(19) United States
(12) Patent Application Publication
(10) Pub. No.: US 2025/0146601 A1
(43) Pub. Date: May 8, 2025

(54) SNAP LOCK FITTING

(71) Applicant: Icon Containment Solutions, LLC, Woods Cross, UT (US)

(72) Inventor: Jason Mitchell, North Salt Lake, UT (US)

(21) Appl. No.: 18/940,821

(22) Filed: Nov. 7, 2024

Related U.S. Application Data
(60) Provisional application No. 63/596,912, filed on Nov. 7, 2023.

(51) Int. Cl. F16L 13/10

(52) U.S. Cl. CPC F16L 13/10

(57) ABSTRACT

Disclosed is a snap-lock fitting for encircling a pipe that passes through an opening and sealing the opening with respect to the pipe. The snap-lock fitting includes a pair of half portions that are configured to join together around a pipe. The half portions include at least one half-cylinder portion extending from a first end to a second end, where the at least one half-cylinder portion has a first mating surface with a ridge and a second mating surface with a recess, and where the ridge of a first of the pair of half portions is configured to engage a recess of a second of the pair of half portions. Also disclosed is a method of installing the snap-lock fitting.

### CROSS-REFERENCES TO RELATED APPLICATIONS

This application claims the benefit of U.S. Provisional Patent Application No. 63/596,912 entitled “SNAP LOCK FITTING” and filed on Nov. 7, 2023, for Jason Mitchell, which is incorporated herein by reference.

### FIELD

This disclosure relates generally to underground storage tank systems of hazardous liquids, and more particularly to mechanisms for sealing pipes and conduits that extend through walls of the sumps within the underground storage tank system.

### BACKGROUND

Numerous conventional sealing devices exist that provide a manner for sealing a tube that extends through a wall. However, for applications wherein the wall is that of an underground tank, conventional devices fail to provide a sealing device that enables an installer to quickly attach a fitting around a pipe without manually holding the fitting in place while an adhesive or solvent weld cures.

### SUMMARY

Disclosed is a snap-lock fitting for encircling a pipe that passes through an opening and sealing the opening with respect to the pipe. The snap-lock fitting includes a pair of half portions that are configured to join together around a pipe. The half portions include at least one half-cylinder portion extending from a first end to a second end, where the at least one half-cylinder portion has a first mating surface with a ridge and a second mating surface with a recess, and where the ridge of a first of the pair of half portions is configured to engage a recess of a second of the pair of half portions.

In certain examples, the snap-lock fitting defines a bore axis, and the ridge extends along the first mating surface in a direction that is substantially parallel with the bore axis. The snap-lock fitting also includes at least one alignment tab extending from one of either the first mating surface or the second mating surface and at least one alignment recess disposed in one of either the first mating surface or the second mating surface, where the at least one alignment recess is configured to receive the at least one alignment tab.

In certain examples, the at least one half-cylinder portion comprises at least a first half-cylinder portion and a second half-cylinder portion, and the first half-cylinder portion has a greater diameter than the second half-cylinder portion. The at least one half-cylinder portion may be tapered and decreases in diameter from the flange to an end opposite the flange.

The snap-lock fitting, in certain examples, includes at least one half-annular ridge formed on an interior surface of the at least one half-cylinder portion, where the at least one half-annular ridge is configured to engage the pipe and form a seal with the pipe.

Also disclosed is a snap-lock fitting that includes a flange. In certain examples, a each of a pair of half portions includes a flange. Each of the half portions may also include at least one half-cylinder portion extending outward from the flange, where the at least one half-cylinder portion has a first mating surface with a ridge and a second mating surface with a recess, and where the ridge of a first of the pair of half portions is configured to engage a recess of a second of the pair of half portions.

In certain examples, the snap-lock fitting defines a bore axis, and the ridge extends along the first mating surface in a direction that is substantially parallel with the bore axis, and/or the ridge extends along the first mating surface in a direction that is substantially perpendicular to the bore axis. The snap-lock fitting also includes, in certain examples, at least one alignment tab extending from one of either the first mating surface or the second mating surface.

The snap-lock fitting also includes at least one alignment recess disposed in one of either the first mating surface or the second mating surface, where the at least one alignment recess is configured to receive the at least one alignment tab. In certain examples, the at least one half-cylinder portion comprises at least a first half-cylinder portion and a second half-cylinder portion, and the first half-cylinder portion has a greater diameter than the second half-cylinder portion.

In certain examples, the at least one half-cylinder portion is tapered and decreases in diameter from the flange to an end opposite the flange. The snap-lock fitting may also include at least one half-annular ridge formed on an interior surface of the at least one half-cylinder portion, where the at least one half-annular ridge is configured to engage the pipe and form a seal with the pipe.

In certain examples, the recess comprises a cross-sectional profile configured to receive and maintain a cross-sectional profile of the ridge. The cross-sectional profile of the ridge may be L-shaped.

Also disclosed is a method of installing the snap-lock fitting.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view diagram of an underground storage tank system, in accordance with examples of the present disclosure;

FIG. 2 is a side view diagram of the snap-lock fitting, in accordance with examples of the subject disclosure;

FIG. 3 is a perspective view diagram illustrating a portion of the snap-lock fitting, in accordance with examples of the subject disclosure;

FIG. 4 is a cross-sectional view of a mating of a snap ridge and a snap recess, in accordance with examples of the subject disclosure;

FIG. 5 is a perspective view diagram illustrating an example of a snap-lock fitting, in accordance with examples of the subject disclosure;

FIG. 6 is a perspective view diagram illustrating another example of a snap-lock fitting, in accordance with examples of the subject disclosure;

FIG. 7 is a perspective view diagram illustrating an example of a snap-lock fitting without a flange, in accordance with examples of the subject disclosure;

FIG. 8 is a perspective view diagram illustrating another example of a snap-lock fitting, in accordance with examples of the subject disclosure; and

FIG. 9 is a schematic flowchart diagram illustrating an example of installing a snap-lock fitting, according to examples of the subject disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

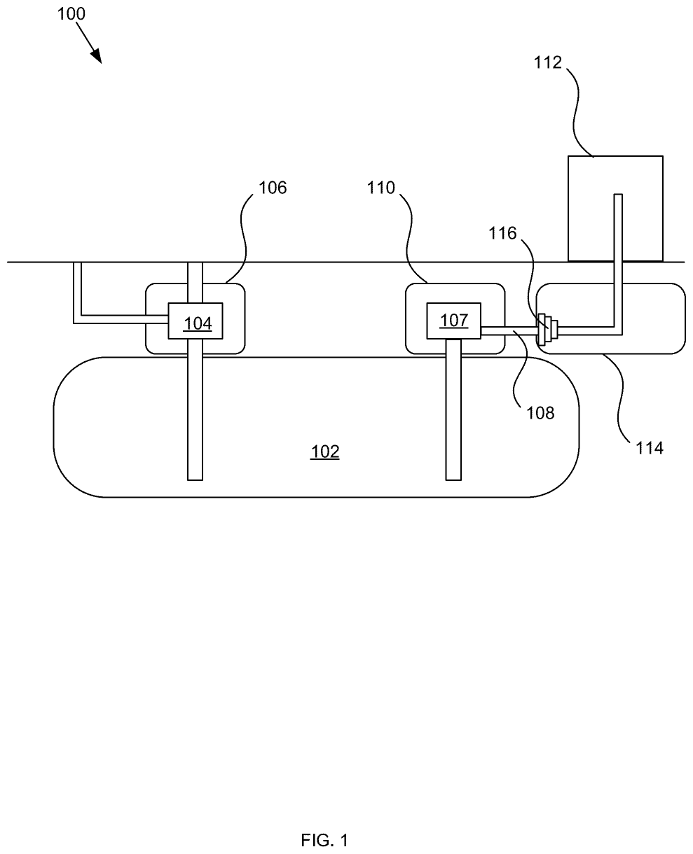

FIG. 1 is a perspective view diagram of an underground storage tank system 100, in accordance with examples of the present disclosure. The use of underground storage tank systems for the storage of hazardous liquids is mandated in some states. Generally speaking, underground storage tank systems 100 include a double-wall underground storage tank 102, a fill pump 104 disposed within a fill sump 106, and a dispenser pump 107 disposed within a dispenser sump 110. The dispenser pump 107 extracts fuel from the tank 102 and pressurizes a dispenser valve 112, or what is commonly referred to as a “fuel pump” by the general populace. Many other components of the underground storage tank system 100 have been omitted from this discussion for clarity.

Pipes for fuel, and other conduits for electrical power and sensor wires pass from one sump to the other. For example, in the depicted example, a pipe passes from the STP sump 110 to a dispenser sump 114. When the pipes or conduits breach a wall of the sump this creates a potential leak point that must be sealed with a fitting. During installation of the storage tank system 100, fittings are positioned around the pipes within the various sumps to prevent ground water, fill, etc., from entering the sumps. More importantly, the system is designed to keep a potential fuel release into the environment from occurring. These fittings frequently need to be replaced but are difficult and time consuming to replace because of the adhesives used to glue together the halves of the fittings. A snap-lock fitting 116, beneficially, simplifies this repair procedure and greatly reduces the need to hold together the fitting while the adhesive cures, as will be discussed in greater detail below. Although FIG. 1 only shows a single snap-lock fitting 116, it is contemplated that the fitting 116 can be used anywhere within one of the various sumps that a wire, pipe, or conduit breaches a wall of the sump or where a test fitting is required.

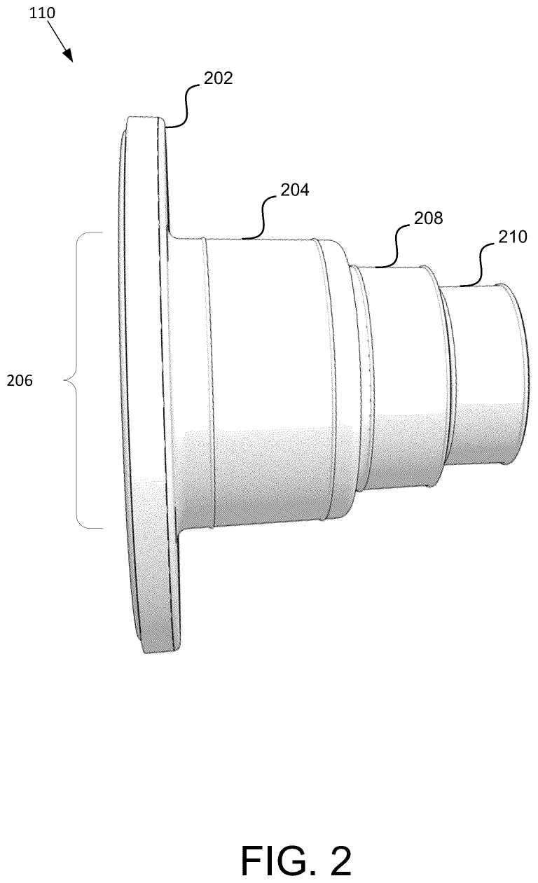

FIG. 2 is a side view diagram of the snap-lock fitting 116, in accordance with examples of the subject disclosure. The snap-lock fitting 116, in certain examples, is formed of a semi-flexible polymer suitable for use in a hostile chemical environment of an underground fuel storage tank system or secondary containment system.

In certain examples, the snap-lock fitting 116 includes a base flange 202 configured to engage an outer surface of the tank or any object through which a pipe or conduit passes, such as the sump 114. The base flange 202 may extend outward radially a distance of between about ½″ and 4″ from a first cylinder portion 204. The snap-lock fitting 116 is, in certain examples, configured with one or more cylinder portions 204, 208, 210. Each of the one or more cylinder portions may have a different diameter 206. A second cylinder portion 208 is coupled with the first cylinder portion 204 and has a smaller diameter than the first cylinder portion 204. A third cylinder portion 210 is coupled with the second cylinder portion 208 and has a smaller diameter than the second cylinder portion 208.

Any reasonable number of stepped cylinder portions are contemplated, and alternatively, there may only be a single cylinder portion (i.e., no “steps”). Beneficially, this allows a user to adapt the snap-lock fitting 116 to different diameter pipes. For example, a user installing the snap-lock fitting 116 on a pipe with a diameter larger than the third cylinder portion 210 may cut off the third cylinder portion 210 with any suitable cutting device. These dimensions are given by way of example only, and it is contemplated that the dimensions of the fitting 116 may be adapted to different situations.

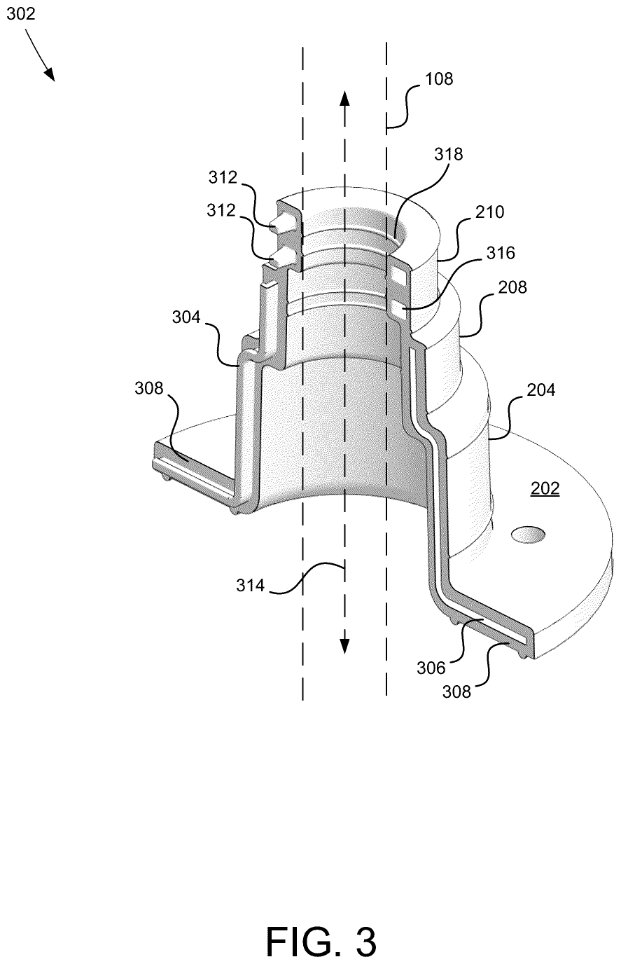

FIG. 3 is a perspective view diagram illustrating a portion of the snap-lock fitting 116, in accordance with examples of the subject disclosure. In particular, FIG. 3 illustrates a half portion 302 of the snap-lock fitting 116. The snap-lock fitting 116, in certain examples, is formed of two halves that snap together around a pipe 108. Beneficially, this type of snap-together assembly helps a user who is installing the snap-lock fitting 116 during a repair/replace procedure because the snap-lock fitting 116 reduces the amount of time a user has to manually hold together the two halves of the snap-lock fitting 116 while an adhesive or a solvent weld cures and bonds the two halves together.

In certain examples, the half portion 302 is configured with a snap ridge 304 and a snap recess 306. The snap ridge 304 is configured to engage the snap recess 306 of an opposing half portion 302. Together, two half portions 302 encircle the pipe 108 and seal the opening in the tank where the pipe 108 passes into the interior area of the tank, or through an exterior wall of the sump 114. The snap ridge 304 mates with the snap recess 306 to secure two half portions 302 together during the installation process.

Although the examples of the present disclosure discuss a snap ridge 304 and a snap recess 306, any similar fitting that is capable of maintaining its position during an adhesive or solvent weld cure process is contemplated. For example, certain types of friction fit protrusions and corresponding recesses are contemplated.

In certain examples, the snap ridge 304 extends outward from a mating surface 308. The snap ridge 304 may extend along substantially the entire length of the mating surface 308 from an outer end of the flange 202 to an end of the third cylinder portion 210. In the depicted embodiment, the snap ridge 304 extends from an outer end of the flange 202 to an end of the second cylinder portion 208 and alignment tabs 312 extend outward from the mating surface of the third cylinder portion 210.

In certain examples, the snap ridge 304 may extend along only certain portions of the mating surface 308. For example, the snap ridge 304 may extend along portions of the mating surface 308 that are substantially parallel with a pipe axis 314. In other examples, the line 314 depicts a bore axis that is defined by two halves joined together to form a complete snap-lock fitting. As used herein, substantially parallel means within ±10 degrees of parallel. In other examples, the snap ridge 304 may only extend along portions of the mating surface 308 that are substantially perpendicular to the pipe axis 314. As used herein, substantially perpendicular means within ±10 degrees of perpendicular. In yet other examples, the snap ridge 304 extends along portions of the mating surface 308 are both substantially parallel and substantially perpendicular, and the transitions between the same.

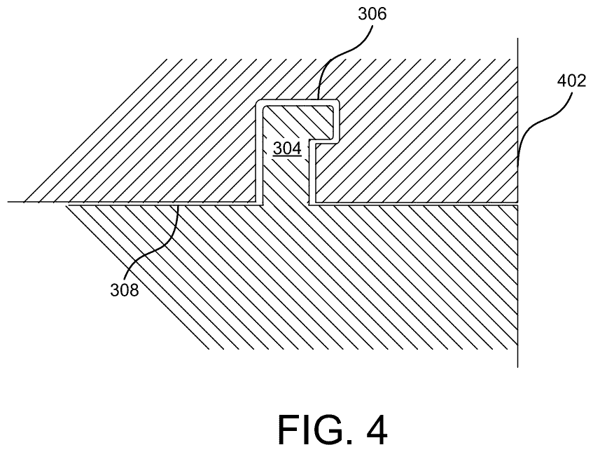

Similarly, the snap recess 306 is formed in a mating surface of the same half portion 302 opposite the snap ridge 304. The snap recess 306 is formed, in certain examples, with a cross-sectional profile that corresponds with a cross-sectional profile of the snap ridge 304, which will be described in greater detail below with reference to FIG. 4. The snap recess 306 may extend along substantially the entire length of the mating surface 308 from an outer end of the flange 202 to an end of the third cylinder portion 210. In the depicted embodiment, the snap recess 306 extends from an outer end of the flange 202 to an end of the second cylinder portion 208.

In certain examples, the snap recess 306 may extend along only portions of the mating surface 308. For example, the snap recess 306 may extend along portions of the mating surface 308 that are substantially parallel with a pipe axis 314. In other examples, the snap recess 306 may only extend along portions of the mating surface 308 that are substantially perpendicular to the pipe axis 314. In yet other examples, the snap recess 306 extends along portions of the mating surface 308 are both substantially parallel and substantially perpendicular, and the transitions between the same.

The alignment tabs 312 are configured to engage alignment recesses 316 of an opposing half portion 302. In certain examples the alignment tabs 312 have a tapered cross-sectional profile, as depicted, to aid in locating a first half portion 302 with a second half portion 302. In other examples, the alignment tabs 312 have any suitable cross-sectional profile.

In certain examples, the snap-lock fitting 116 includes one or more annular ridges 318 formed on an interior surface of the half portion 302. Each of these annular ridges 318 are useful in forming a seal with the pipe 108 and act in a manner similar to that of an O-ring. In other words, the annular ridges 318 function as integrated O-rings to form a seal between the pipe 108 and the snap-lock fitting 116.

FIG. 4 is a cross-sectional view of a mating of a snap ridge 304 and a snap recess 306, in accordance with examples of the subject disclosure. In the depicted embodiment, the snap ridge 304 has an “L” shape cross section. In this example, the snap ridge 304 extends outward from the mating surface 308 and turns to extend towards an exterior surface 402 of the snap-lock fitting 116. The snap recess 306 has, in certain examples, a cross-sectional profile that corresponds with but is slightly larger than the cross-sectional profile of the snap ridge 304. In other words, the snap recess 306 is dimensioned to accommodate the insertion of the snap ridge 304. Generally speaking, in certain examples, an overall width of the snap recess 306 at its widest point is between about 5% and 10% greater than a corresponding width of the snap ridge 304. As used herein, “about” means a range of values that are within either ±10% of the referenced value.

While the widest part of “L” of the snap ridge 304 may be wider than an entrance of the snap recess 306, the material of the snap-lock fitting 116 is flexible enough to allow the “L” to compress during insertion and “snap” into the widest portion of the snap recess 306. It is contemplated that other cross-sectional profiles are suitable for locking together two half portions 302. For example, the “L” profile depicted may include tapered surfaces, etc. In other examples, the “L” profile may be replaced with other geometric shapes that are lockable within a correspondingly shaped recess, for example a T-shaped cross-section, an inverted cone shape, a wedge shape, etc. In other words, any suitable cross-section with a shape having a feature that is larger than the portion of the cross-section that connects with the surface 308. However, the “L” shape profile depicted beneficially is easily inserted and provides enough pull-apart resistance that adhesives or solvent welds have enough time to cure without needing a user to hold together half portions. In other examples, a snap ridge 304 may have a square, cylindrical, or rectangular cross-section and the snap recess 306 has dimensions that are suitable for a friction fit connection between the snap ridge 304 and the snap recess 306.

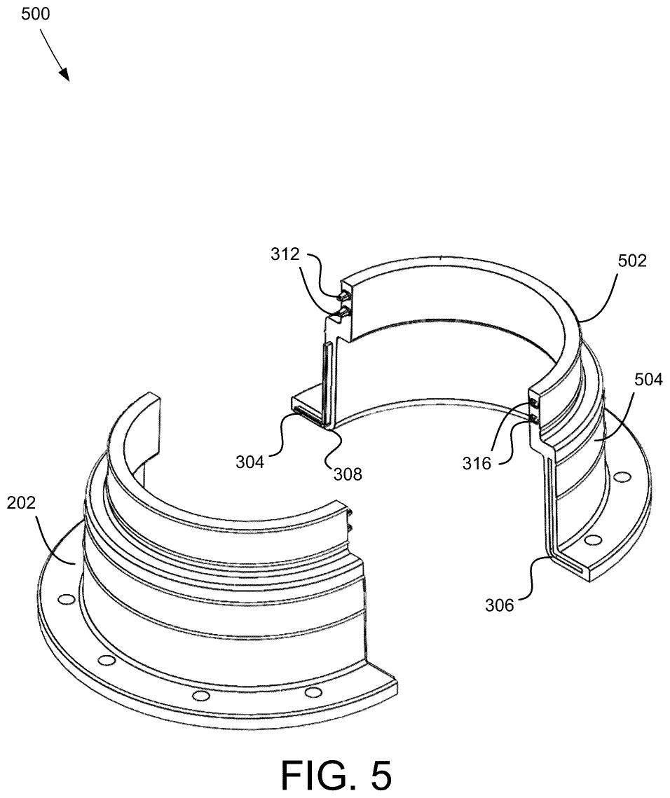

FIG. 5 is a perspective view diagram illustrating an example of a snap-lock fitting 500, in accordance with examples of the subject disclosure. In particular, FIG. 5 illustrates snap lock fitting having two cylinder portions 502, 504 that extend from the flange 202. As described above, the two cylinder portions 502, 504 have different diameters. The snap-lock fitting 500, in certain examples, is formed of two identical halves that snap together around a pipe 108.

In certain examples, the half portions of the snap lock fitting 500 are configured with a snap ridge 304 and a snap recess 306. The snap ridge 304 is configured to engage the snap recess 306 of an opposing half portion. Together, two half portions encircle the pipe 108 and seal the opening in the tank where the pipe 108 passes into the interior area of the tank, or through an exterior wall of the sump 114. The snap ridge 304 mates with the snap recess 306 to secure two half portions together during the installation process.

As with the examples described above with reference to FIGS. 2-4, the snap ridge 304 extends outward from a mating surface 308. The snap ridge 304 may extend along substantially the entire length of the mating surface 308 from an outer end of the flange 202 to an end of the cylinder portion 504. In the depicted embodiment, the snap ridge 304 extends from an outer end of the flange 202 to an end of the first cylinder portion 504 and alignment tabs 312 extend outward from the mating surface of the second cylinder portion 502.

The alignment tabs 312 are configured to engage alignment recesses 316 of an opposing half portion. In certain examples the alignment tabs 312 have a tapered cross-sectional profile, as depicted, to aid in locating a first half portion with a second half portion. In other examples, the alignment tabs 312 have any suitable cross-sectional profile.

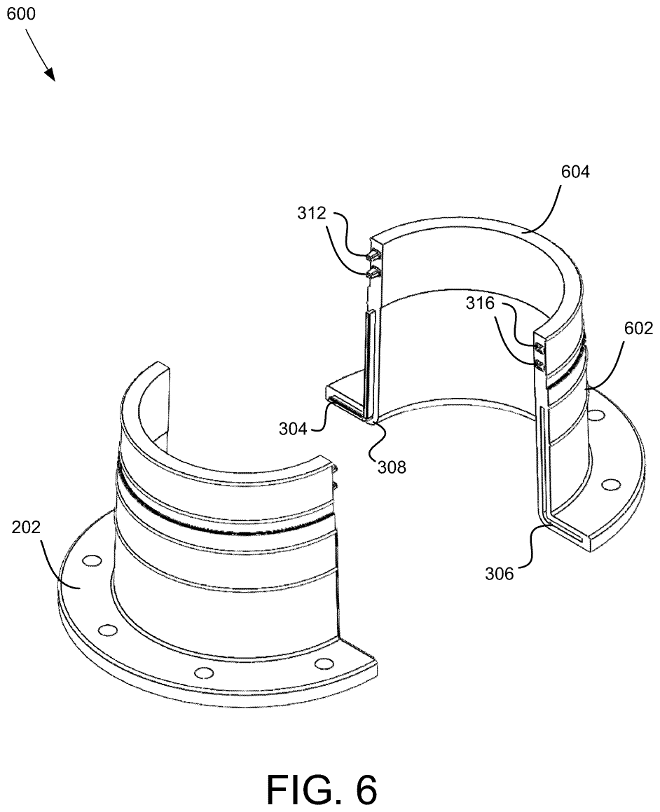

FIG. 6 is a perspective view diagram illustrating another example of a snap-lock fitting 600, in accordance with examples of the subject disclosure. In particular, FIG. 6 illustrates snap lock fitting having a single, tapered cylinder portion 602 that extends from the flange 202. The tapered cylinder portion 602, in certain examples, extends from the flange 202 to an end 604 that engages the pipe 108. Because the snap-lock fitting 600 is formed of a semi-flexible or flexible material, the end 604 is configured to adapt to a range of pipe 108 diameters and encircle and form a seal around the pipe 108 at the end 604. The snap-lock fitting 600, in certain examples, is formed of two identical halves that snap together around the pipe 108.

In certain examples, the half portions of the snap lock fitting 600 are configured with a snap ridge 304 and a snap recess 306. The snap ridge 304 is configured to engage the snap recess 306 of an opposing half portion. Together, two half portions encircle the pipe 108 and seal the opening in the tank where the pipe 108 passes into the interior area of the tank, or the opening through an exterior wall of the sump 114. The snap ridge 304 mates with the snap recess 306 to secure two half portions together during the installation process.

As with the examples described above with reference to FIGS. 2-5, the snap ridge 304 extends outward from a mating surface 308. The snap ridge 304 may extend along substantially the entire length of the mating surface 308 from an outer end of the flange 202 to an end of the cylinder portion 504. In the depicted embodiment, the snap ridge 304 extends from an outer end of the flange 202 to a tapered cylinder portion 602. In other examples, the snap ridge 304 extends to an area adjacent to the alignment tabs 312. The alignment tabs 312 are configured to engage alignment recesses 316 of an opposing half portion. In certain examples the alignment tabs 312 have a tapered cross-sectional profile, as depicted, to aid in locating a first half portion with a second half portion. In other examples, the alignment tabs 312 have any suitable cross-sectional profile.

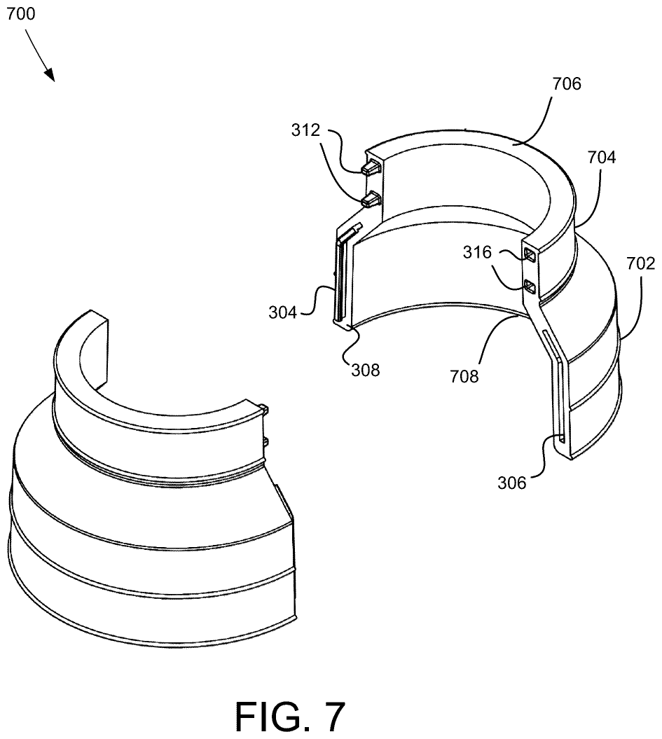

FIG. 7 is a perspective view diagram illustrating an example of a snap-lock fitting 700 without a flange, in accordance with examples of the subject disclosure. In particular, FIG. 7 illustrates a snap lock fitting having two cylinder portions 702, 704 of different diameters that extend from a first end 706 to a second end 708. As described above, the two cylinder portions 702, 704 have different diameters. The snap-lock fitting 700, in certain examples, is formed of two identical halves that snap together around a pipe 108.

In certain examples, the half portions of the snap lock fitting 700 are configured with a snap ridge 304 and a snap recess 306. The snap ridge 304 is configured to engage the snap recess 306 of an opposing half portion. Together, two half portions encircle the pipe 108 and seal the opening in the tank where the pipe 108 passes into the interior area of the tank, or an opening through an exterior wall of the sump 114. The snap ridge 304 mates with the snap recess 306 to secure two half portions together during the installation process.

As with the examples described above with reference to FIGS. 2-6, the snap ridge 304 extends outward from a mating surface 308. The snap ridge 304 may extend along substantially the entire length of the mating surface 308 the second end 708 to the first end 706. In the depicted embodiment, the snap ridge 304 extends from the second end 708 to a transition between the first cylinder portion 702 and the second cylinder portion 704, and alignment tabs 312 extend outward from the mating surface of the second cylinder portion 704.

The alignment tabs 312 are configured to engage alignment recesses 316 of an opposing half portion. In certain examples the alignment tabs 312 have a tapered cross-sectional profile, as depicted, to aid in locating a first half portion with a second half portion. In other examples, the alignment tabs 312 have any suitable cross-sectional profile.

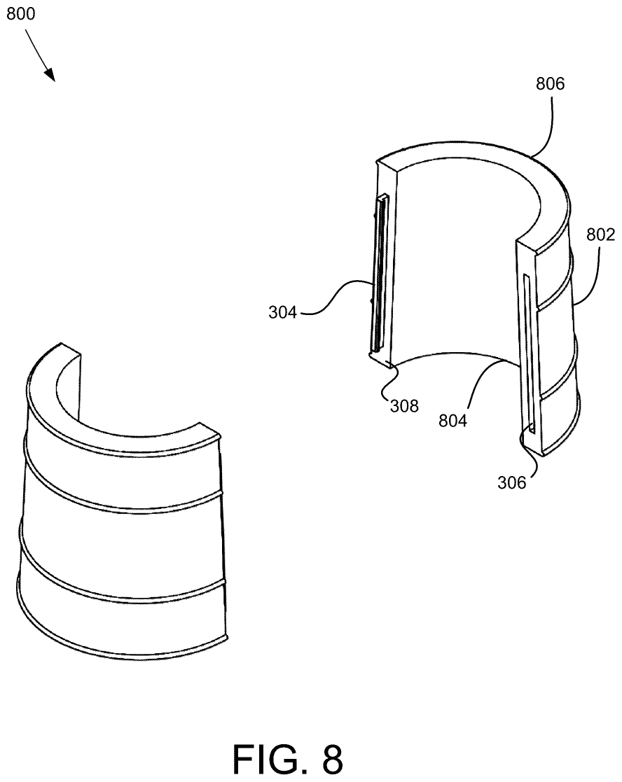

FIG. 8 is a perspective view diagram illustrating another example of a snap-lock fitting 800, in accordance with examples of the subject disclosure. In particular, FIG. 8 illustrates snap lock fitting having a single, tapered cylinder portion 802 without a flange. The tapered cylinder portion 802, in certain examples, extends from the a first end 804 to a second end 806 that engages the pipe 108. Because the snap-lock fitting 800 is formed of a semi-flexible or flexible material, the end 806 is configured to adapt to a range of pipe 108 diameters and encircle and form a seal around the pipe 108 at the end 806. The snap-lock fitting 800, in certain examples, is formed of two identical halves that snap together around the pipe 108.

In certain examples, the half portions of the snap lock fitting 800 are configured with a snap ridge 304 and a snap recess 306. The snap ridge 304 is configured to engage the snap recess 306 of an opposing half portion. Together, two half portions encircle the pipe 108 and seal the opening in the tank where the pipe 108 passes into the interior area of the tank, or the opening through an exterior wall of the sump 114. The snap ridge 304 mates with the snap recess 306 to secure two half portions together during the installation process.

As with the examples described above with reference to FIGS. 2-7, the snap ridge 304 extends outward from a mating surface 308. The snap ridge 304 may extend along substantially the entire length of the mating surface 308 from the first end 804 to the second end 806.

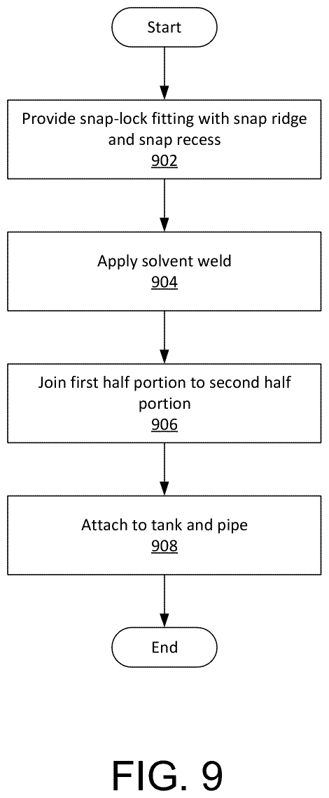

FIG. 9 is a schematic flowchart diagram illustrating an example of installing a snap-lock fitting 116, according to examples of the subject disclosure. The method, in certain examples, includes at block 902 providing a snap-lock fitting with a snap ridge and a snap recess. The snap ridge and snap recess are positioned and configured as described above with reference to FIGS. 2-4. At block 904, the method includes applying a solvent weld or adhesive to at least a first half portion and/or a second half portion of the snap-lock fitting. At block 906, the method includes joining the first half portion to the second half portion around a pipe and allowing the solvent weld or adhesive to cure. At block 908, the method includes attaching or securing the snap-lock fitting to the tank and the pipe. In certain examples, threaded rods extend outward from the tank and openings in the flange of the snap-lock fitting engage the threaded rods and allow a user to bolt the snap-lock fitting to the tank. In other examples, a user may install a hose clamp around an end of the snap-lock fitting to secure and seal the snap-lock fitting to the pipe.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A snap-lock fitting, comprising:
a pair of half portions that are configured to join together around a pipe, where each of the half portions comprises:
a flange;
at least one half-cylinder portion extending outward from the flange, where the at least one half-cylinder portion has a first mating surface with a ridge and a second mating surface with a recess, and where the ridge of a first of the pair of half portions is configured to engage a recess of a second of the pair of half portions.

2. The snap-lock fitting of claim 1, where the snap-lock fitting defines a bore axis, and the ridge extends along the first mating surface in a direction that is substantially parallel with the bore axis.

3. The snap-lock fitting of claim 2, where the ridge extends along the first mating surface in a direction that is substantially perpendicular to the bore axis.

4. The snap-lock fitting of claim 1, further comprising at least one alignment tab extending from one of either the first mating surface or the second mating surface.

5. The snap-lock fitting of claim 4, further comprising at least one alignment recess disposed in one of either the first mating surface or the second mating surface, where the at least one alignment recess is configured to receive the at least one alignment tab.

6. The snap-lock fitting of claim 1, where the at least one half-cylinder portion comprises at least a first half-cylinder portion and a second half-cylinder portion.

7. The snap-lock fitting of claim 6, where the first half-cylinder portion has a greater diameter than the second half-cylinder portion.

8. The snap-lock fitting of claim 1, where the at least one half-cylinder portion is tapered and decreases in diameter from the flange to an end opposite the flange.

9. The snap-lock fitting of claim 1, further comprising at least one half-annular ridge formed on an interior surface of the at least one half-cylinder portion, where the at least one half-annular ridge is configured to engage the pipe and form a seal with the pipe.

10. The snap-lock fitting of claim 1, where the recess comprises a cross-sectional profile configured to receive and maintain a cross-sectional profile of the ridge.

11. The snap-lock fitting of claim 10, where the cross-sectional profile of the ridge is L-shaped.

12. A snap-lock fitting, comprising:
a pair of half portions that are configured to join together around a pipe, where each of the half portions comprises:
at least one half-cylinder portion extending from a first end to a second end, where the at least one half-cylinder portion has a first mating surface with a ridge and a second mating surface with a recess, and where the ridge of a first of the pair of half portions is configured to engage a recess of a second of the pair of half portions.

13. The snap-lock fitting of claim 12, where the snap-lock fitting defines a bore axis, and the ridge extends along the first mating surface in a direction that is substantially parallel with the bore axis.

14. The snap-lock fitting of claim 12, further comprising at least one alignment tab extending from one of either the first mating surface or the second mating surface.

15. The snap-lock fitting of claim 14, further comprising at least one alignment recess disposed in one of either the first mating surface or the second mating surface, where the at least one alignment recess is configured to receive the at least one alignment tab.

16. The snap-lock fitting of claim 12, where the at least one half-cylinder portion comprises at least a first half-cylinder portion and a second half-cylinder portion.

17. The snap-lock fitting of claim 16, where the first half-cylinder portion has a greater diameter than the second half-cylinder portion.

18. The snap-lock fitting of claim 12, where the at least one half-cylinder portion is tapered and decreases in diameter from the first end to the second end.

19. The snap-lock fitting of claim 12, further comprising at least one half-annular ridge formed on an interior surface of the at least one half-cylinder portion, where the at least one half-annular ridge is configured to engage the pipe and form a seal with the pipe.

20. A method comprising:
providing a pipe fitting comprising:
a pair of half portions that are configured to join together around a pipe, where each of the half portions comprises at least one half-cylinder portion extending from a first end to a second end, where the at least one half-cylinder portion has a first mating surface with a ridge and a second mating surface with a recess, and where the ridge of a first of the pair of half portions is configured to engage a recess of a second of the pair of half portions; and
applying a solvent weld to at least one of the pair of half portions; and
joining the pair of half portions around a pipe.
